(19) United States
(12) Patent Application Publication
(10) Pub. No.: US 2024/0247676 A1
(43) Pub. Date: Jul. 25, 2024

(54) FASTENING ARRANGEMENT COMPRISING A THREAD-FORMING SCREW AND A CURED ALUMINATE-CONTAINING INORGANIC COMPOSITION

(71) Applicant: HILTI AKTIENGESELLSCHAFT, Schaan (LI)

(72) Inventors: Markus SCHÖNLEIN, Gilching (DE); Memet-Emin Kumru, Augsburg (DE)

(73) Assignee: HILTI AKTIENGESELLSCHAFT, Schaan (LI)

(21) Appl. No.: 18/576,359

(22) PCT Filed: Jun. 22, 2022
(86) PCT No.: PCT/EP2022/067027

§ 371 Date: Jan. 3, 2024

(30) Foreign Application Priority Data
Jul. 8, 2021 (EP) 21184423.8

(51) Int. Cl. F16B 39/02; C04B 14/30; C04B 22/06; C04B 22/14; C04B 22/16; C04B 24/06; C04B 28/06; C04B 103/10; C04B 103/20; C04B 103/30; C04B 111/00; F16B 25/00

(52) U.S. Cl. CPC F16B 39/021; C04B 14/303; C04B 22/062; C04B 22/147; C04B 22/165; C04B 24/06; C04B 28/065; F16B 25/0026; C04B 2103/10; C04B 2103/20; C04B 2103/30; C04B 2111/00715; F16B 25/0073

(57) ABSTRACT

A fastening arrangement is made with a screw that has a shank, at least one thread helix being arranged on the shank, and a cured compound. The screw is arranged in a hole in a substrate, and a gap between the shank and the hole wall is filled with a cured aluminate-containing inorganic composition.

The invention relates to a fastening arrangement comprising a thread-forming screw and a cured aluminate-containing inorganic composition, the thread-forming screw being arranged in a hole in a substrate, in particular in a mineral building material such as concrete, and a gap being provided between the shank of the screw and the hole wall, which gap is filled with the cured aluminate-containing inorganic composition.

A thread-forming screw for screwing into hard substrates is known from EP 0 623 759 B1. An internally threaded sleeve having a self-cutting thread is known from EP 1 536 149 A2. U.S. Pat. No. 4,350,464 A discloses an anchor rod that can be set by means of striking, which has a self-tapping thread on a shank as the main body.

A disadvantage of the known solutions is that, due to the properties of the substrate and the type and condition of the tool for creating the hole, the size of the annular gap between the outer surface of the screw main body and the hole wall can vary greatly from fastening point to fastening point. In addition, high loads can act on the undercuts created by the thread in the substrate, which lead to a partial or—in the most extreme case—to a complete failure of the created fastening point. In order to avoid this and to achieve a high load-bearing capacity, thread-forming screws of this kind, in particular concrete screws, have a relatively long grip length of the thread in the substrate; however, this requires a great deal of effort to set the corresponding screw.

In addition, conventional concrete screws that are not combined with a chemical binder during the installation process result in poor bonding due to cracks and cavities along the screw/concrete boundary surface. This poor bonding results in low load values and allows the penetration of corrosive chemicals such as chlorides.

A thread-forming screw which is set in a borehole filled beforehand with a curable compound is known from DE 198 20 671 A1, DE 103 11 471 A1 or DE 10 2006 000 414 A1. The thread of the screw is anchored in the substrate and in the compound after the curable compound has been cured.

Known curable compounds, such as the two-component mortar based on epoxy known from DE 10002605 A1 or the two-component mortar based on radically curable compounds known from DE 3514031 A1, have a high filler content, which ensures high viscosity and low shrinkage behavior when the cured compound has a sufficient internal strength.

Another disadvantage of the solution according to DE 198 20 671 A1 is that the annular gap between the outer surface of the main body of the screw and the borehole wall must be of sufficient size so that curable compounds containing fillers can also be used in addition to low-viscosity compounds. To completely fill this annular gap, a large amount of the curable compound is therefore required.

The cartridge systems known for other fastening elements, such as anchor rods and the like, such as those known from EP 0 431 302 A2, EP 0 432 087 A1, EP 0 312 776 A1 or EP 0 638 705 A1, due to the very small annular gap, are not suitable for use with thread-forming screws because these cartridge systems either contain fillers that are too coarse-grained or the cartridges cannot be crushed using conventional thread-forming screws or the cartridges themselves produce particles that are too large even when crushed. Since only a few turns of the screw are possible in this application before the screw is set, it must be ensured that the curable compound is mixed quickly so that it cures reliably, which previously has not been possible with the known compounds. Conventional organic binder systems, such as resins, can strengthen the bond between the screw and the concrete, but this effect is lost at elevated temperatures.

The object of the invention is to specify a fastening arrangement that is particularly easy and safe to create and with which an efficient and reliable fastening of a thread-forming screw is possible, in particular strengthens the bond, leading to an increase in the load values, which is also maintained at high in-service temperatures and in the event of a fire.

According to the invention, this object is achieved by a fastening arrangement having the features of claim 1. Preferred embodiments are given in the dependent claims.

The fastening arrangement according to the invention is characterized in that the cured compound can be obtained by curing a multi-component cementitious aluminate-containing inorganic system, which contains, in one component, at least one aluminate-containing cement constituent and at least one blocking agent selected from the group consisting of phosphoric acid, metaphosphoric acid, phosphorous acid, phosphinic acids and boric acid, in aqueous phase, and, in a further component, an initiator for the aluminate-containing cement constituent.

The multi-component cementitious aluminate-containing inorganic system, which is used in the fastening arrangement according to the invention, contains, in one component (also known as an aluminum-containing component), at least one aluminate-containing cement constituent and at least one blocking agent selected from the group consisting of phosphoric acid, metaphosphoric acid, phosphorous acid, phosphinic acids and boric acid, in aqueous phase, and, in a further component (also known as an initiator component), an initiator for the aluminate-containing cement.

The aluminate-containing components and the initiator component are packaged so as to be spatially separated from one other until the cementitious inorganic system is used, so that a reaction takes place only when the two components are brought into contact with one other.

The two components are usually packaged in film pouches and are available either as a side-by-side system or as a pouch-in-pouch system. In general, however, any packaging and packaging form is possible in which the two components are packaged separately from one another and which can be easily opened by setting the thread-forming screw and ground up by the screw.

The aluminate-containing component contains an aluminate-containing cement constituent based on a calcium aluminate cement (CAC) in aqueous phase or a calcium sulfoaluminate cement (CAS) in aqueous phase. The aluminate-containing cement constituent, in particular the cement constituent containing calcium aluminate which can be used in the present invention, is characterized by rapid setting and curing, rapid drying and shrinkage compensation when mixed with calcium sulfates, and excellent corrosion resistance and shrinkage resistance. Such a calcium aluminate cement which is suitable to be used in the present invention is for example Ternal™ White (Imerys, France).

When the aluminate-containing component comprises a mixture of aluminum-containing cement (CAC) and calcium sulfate (CaSO4), rapid ettringite formation occurs during hydration. In concrete chemistry, hexacalcium aluminate trisulfate hydrate is formed by reacting calcium aluminate with calcium sulfate, resulting in rapid setting and curing, as well as shrinkage compensation or even expansion. Shrinkage compensation can be achieved with a moderate increase in sulfate content.

The aluminate-containing component comprises at least approximately 40 wt. %, preferably at least approximately 50 wt. %, more preferably at least approximately 60 wt. %, most preferably at least approximately 70 wt. %, from approximately 40 wt. % to approximately 95 wt. %, preferably from approximately 50 wt. % to approximately 90 wt. %, more preferably from approximately 65 wt. % to approximately 85 wt. %, most preferably from approximately 70 wt. % to approximately 80 wt. %, aluminum-containing cement, based on the total weight of the aluminate-containing component.

Alternatively, the aluminate-containing component can comprise at least approximately 20 wt. %, preferably at least approximately 30 wt. %, more preferably at least approximately 40 wt. %, most preferably at least approximately 50 wt. %, from approximately 20 wt. % to approximately 80 wt. %, preferably from approximately 30 wt. % to approximately 70 wt. %, more preferably from approximately 35 wt. % to approximately 60 wt. %, most preferably from approximately 40 wt. % to approximately 55 wt. %, aluminum-containing cement, based on the total weight of the aluminate-containing component, and at least approximately 5 wt. %, preferably at least approximately 10 wt. %, more preferably at least approximately 15 wt. %, most preferably at least approximately 20 wt. %, from approximately 1 wt. % to approximately 50 wt. %, preferably from approximately 5 wt. % to approximately 40 wt. %, more preferably from approximately 10 wt. % to approximately 30 wt. %, most preferably from approximately 15 wt. % to approximately 25 wt. %, calcium sulfate, preferably calcium sulfate hemihydrate, based on the total weight of the aluminate-containing component.

The blocking agent contained in the aluminate-containing component is selected from the group consisting of phosphoric acid, metaphosphoric acid, phosphorous acids, phosphinic acids and boric acid, is preferably phosphoric acid or metaphosphoric acid, is most preferably phosphoric acid, in particular an 85% aqueous solution of phosphoric acid. The aluminate-containing component comprises at least approximately 0.1 wt. %, preferably at least approximately 0.3 wt. %, more preferably at least approximately 0.4 wt. %, most preferably at least approximately 0.5 wt. %, from approximately 0.1 wt. % to approximately 20 wt. %, preferably from approximately 0.1 wt. % to approximately 15 wt. %, more preferably from approximately 0.1 wt. % to approximately 10 wt. %, most preferably from approximately 0.3 wt. % to approximately 10 wt. %, of the blocking agent, based on the total weight of the aluminate-containing component. In a preferred embodiment, the aluminate-containing component comprises from approximately 0.3 wt. % to approximately 10 wt. % of an 85 wt. % aqueous solution of phosphoric acid, based on the total weight of the aluminate-containing component.

The aluminate-containing component can contain a plasticizer. Suitable plasticizers are known to a person skilled in the art and can for example be selected from polyacrylic acid polymers with low molecular weight (LMW), superplasticizers from the family of polyphosphonate polyox and polycarbonate polyox, and ethacrylic superplasticizers from the polycarboxylate ether group, and mixtures thereof, for example Ethacryl™ G (Coatex, Arkema Group, France), Acumer™ 1051 (Rohm and Haas, UK) or Sika® VisoCrete®-20 HE (Sika, Germany). Suitable plasticizers are commercially available products. The aluminate-containing component can comprise at least approximately 0.2 wt. %, preferably at least approximately 0.3 wt. %, more preferably at least approximately 0.4 wt. %, most preferably approximately 0.5 wt. %, from approximately 0.2 wt. % to approximately 20 wt. %, preferably from approximately 0.3 wt. % to approximately 15 wt. %, more preferably from approximately 0.4 wt. % to approximately 10 wt. %, most preferably from approximately 0.5 wt. % to approximately 5 wt. %, of the plasticizer, based on the total weight of the aluminate-containing component.

In an advantageous embodiment, the aluminate-containing component can further comprise the following characteristics, alone or in combination.

The aluminate-containing component can additionally comprise a thickener. The thickeners that can be used are known to a person skilled in the art and can be selected from the group consisting of organic products such as xanthan gum, welan gum or DIUTAN® gum (CPKelko, USA), ethers derived from starch, ethers derived from guar, polyacrylamide, carrageenan, agar, and mineral products such as clay, and the mixtures thereof. Suitable thickeners are commercially available products. The aluminate-containing component can comprise least approximately 0.01 wt. %, preferably at least approximately 0.1 wt. %, more preferably at least approximately 0.2 wt. %, most preferably at least approximately 0.3 wt. %, from approximately 0.01 wt. % to approximately 10 wt. %, preferably from approximately 0.1 wt. % to approximately 5 wt. %, more preferably from approximately 0.2 wt. % to approximately 1 wt. %, most preferably from approximately 0.3 wt. % to approximately 0.7 wt. %, of the thickener, based on the total weight of the aluminate-containing component.

The aluminate-containing component can also comprise an antibacterial or biocide agent. The antibacterial or biocide agent can be selected from the group consisting of compounds from the isothiazolinone family such as methylisothiazolinone (MIT), octylisothiazolinone (OIT) and benzisothiazolinone (BIT) and the mixtures thereof. Suitable antibacterial or biocide agents are commercially available products. Ecocid K35R (Progiven, France) and Nuospet OB 03 (Ashland, the Netherlands) are given as examples. The aluminate-containing component can comprise at least approximately 0.001 wt. %, preferably at least approximately 0.005 wt. %, more preferably at least approximately 0.01 wt. %, most preferably at least approximately 0.015 wt. %, from approximately 0.001 wt. % to approximately 1.5 wt. %, preferably from approximately 0.005 wt. % to approximately 0.1 wt. %, more preferably from approximately 0.01 wt. % to approximately 0.075 wt. %, most preferably from approximately 0.015 wt. % to approximately 0.03 wt. % of the antibacterial or biocide agent, based on the total weight of the aluminate-containing component.

The aluminate-containing component can also comprise at least one filler, in particular an organic or mineral filler. The filler can be selected from the group consisting of quartz powder, preferably quartz powder having an average particle size (d50%) of approximately 16 μm, quartz sand, clay, fly ash, quartz dust, carbonate compounds, pigments, titanium oxides, light fillers and the mixtures thereof. Suitable mineral fillers are commercially available products. Quartz powder Millisil W12 or W6 (Quarzwerke GmbH, Germany) is given as an example. The aluminate-containing component can comprise at least approximately 1 wt. %, preferably at least approximately 2 wt. %, more preferably at least approximately 5 wt. %, most preferably at least approximately 8 wt. %, from approximately 1 wt. % to approximately 50 wt. %, preferably from approximately 2 wt. % to approximately 40 wt. %, more preferably from approximately 5 wt. % to approximately 30 wt. %, most preferably from approximately 8 wt. % to approximately 20 wt. %, of the at least one filler, based on the total weight of the aluminate-containing component.

The water content contained in the aluminate-containing component is at least approximately 1 wt. %, preferably at least approximately 5 wt. %, more preferably at least approximately 10 wt. %, most preferably at least approximately 20 wt. %, from approximately 1 wt. % to approximately 50 wt. %, preferably from approximately 5 wt. % to approximately 40 wt. %, more preferably from approximately 10 wt. % to approximately 30 wt. %, most preferably from approximately 15 wt. % to approximately 25 wt. %, based on the total weight of the aluminate-containing component.

The presence of a plasticizer, a thickener and an antibacterial or biocide agent does not alter the overall inorganic nature of the cementitious component.

The aluminate-containing component is present in aqueous phase, preferably in the form of a slurry or paste.

The initiator component of the present invention comprises an initiator for the aluminate-containing cement constituent.

The initiator present in the initiator component consists of an activator component and an accelerator component which comprise a mixture of alkali and/or alkaline earth metal salts.

In particular, the activator component comprises at least one alkali and/or alkaline earth metal salt selected from the group consisting of hydroxides, chlorides, sulfates, phosphates, monohydrogen phosphates, dihydrogen phosphates, nitrates, carbonates and mixtures thereof; preferably the activator component is an alkali and/or alkaline earth metal salt, more preferably it is a calcium metal salt such as calcium hydroxide, calcium sulfate, calcium carbonate or calcium phosphate, a sodium metal salt such as sodium hydroxide, sodium sulfate, sodium carbonate or sodium phosphate, a potassium metal salt such as potassium hydroxide, potassium sulfate, potassium carbonate or potassium phosphate, or a lithium metal salt such as lithium hydroxide, lithium sulfate, lithium carbonate or lithium phosphate, most preferably it is sodium hydroxide.

The initiator component comprises at least approximately 0.01 wt. %, preferably at least approximately 0.02 wt. %, more preferably at least approximately 0.05 wt. %, most preferably at least approximately 1 wt. %, from approximately 0.01 wt. % to approximately 40 wt. %, preferably from approximately 0.02 wt. % to approximately 35 wt. %, more preferably from approximately 0.05 wt. % to approximately 30 wt. %, most preferably from approximately 1 wt. % to approximately 25 wt. %, of the activator, based on the total weight of the initiator component.

The water content contained in the initiator component is at least approximately 1 wt. %, preferably at least approximately 5 wt. %, more preferably at least approximately 10 wt. %, most preferably at least approximately 20 wt. %, from approximately 1 wt. % to approximately 60 wt. %, preferably from approximately 5 wt. % to approximately 50 wt. %, more preferably from approximately 10 wt. % to approximately 40 wt. %, most preferably from approximately 15 wt. % to approximately 30 wt. %, based on the total weight of the initiator component.

The accelerator component comprises at least one alkali and/or alkaline earth metal salt selected from the group consisting of hydroxides, chlorides, sulfates, phosphates, monohydrogen phosphates, dihydrogen phosphates, nitrates, nitrides, carbonates and mixtures thereof; preferably the accelerator component is an alkali and/or alkaline earth metal salt, also preferably it is a water-soluble alkali and/or alkaline earth metal salt, more preferably it is a calcium metal salt such as calcium hydroxide, calcium sulfate, calcium carbonate, calcium chloride, calcium formate or calcium phosphate, a sodium metal salt such as sodium hydroxide, sodium sulfate, sodium carbonate, sodium chloride, sodium formate or sodium phosphate, or a lithium metal salt such as lithium hydroxide, lithium sulfate, lithium sulfate monohydrate, lithium carbonate, lithium chloride, lithium formate or lithium phosphate, most preferably it is lithium sulfate or lithium sulfate monohydrate.

The initiator component comprises at least approximately 0.01 wt. %, preferably at least approximately 0.05 wt. %, more preferably at least approximately 0.1 wt. %, most preferably at least approximately 1.0 wt. %, from approximately 0.01 wt. % to approximately 25 wt. %, preferably from approximately 0.05 wt. % to approximately 20 wt. %, more preferably from approximately 0.1 wt. % to approximately 15 wt. %, most preferably from approximately 1.0 wt. % to approximately 10 wt. %, of the accelerator, based on the total weight of the initiator component.

In a particularly preferred embodiment, the activator component comprises an alkali hydroxide and the accelerator component comprises a lithium salt. In an even more preferred embodiment, the activator component is a sodium hydroxide and the accelerator component is a lithium sulfate.

The initiator component can also contain at least one retarder. In order to ensure sufficient working time, at least one retarder, which prevents premature curing of the mortar composition, can be used in a certain concentration in addition to the initiator component.

The at least one retarder contained in the initiator component according to the present invention is selected from the group consisting of citric acid, tartaric acid, lactic acid, salicylic acid, gluconic acid and mixtures thereof; it is preferably a mixture of citric acid and tartaric acid. The initiator component comprises at least approximately 0.1 wt. %, preferably at least approximately 0.2 wt. %, more preferably at least approximately 0.5 wt. %, most preferably at least approximately 1.0 wt. %, from approximately 0.1 wt. % to approximately 25 wt. %, preferably from approximately 0.2 wt. % to approximately 15 wt. %, more preferably from approximately 0.5 wt. % to approximately 15 wt. %, most preferably from approximately 1.0 wt. % to approximately 10 wt. %, of the retarder, based on the total weight of the initiator component. In a particularly preferred embodiment of the initiator component, the ratio of citric acid/tartaric acid is 1.6/1.

The initiator component can also contain at least one mineral filler. The at least one mineral filler can be selected, for example, from limestone fillers or quartz fillers, quartz sand, sand, corundum crushed stones, gravel, pebbles and mixtures thereof; limestone fillers, such as various calcium carbonates, are preferred. Should fillers be present in the initiator component, a calcium carbonate or mixture of calcium carbonates is most preferred. The initiator component can comprise at least approximately 20 wt. %, preferably at least approximately 25 wt. %, more preferably at least approximately 30 wt. %, also more preferably at least approximately 35 wt. %, most preferably at least approximately 40 wt. %, from approximately 20 wt. % to approximately 95 wt. %, preferably from approximately 25 wt. % to approximately 90 wt. %, more preferably from approximately 30 wt. % to approximately 85 wt. %, also more preferably from approximately 35 wt. % to approximately 80 wt. %, most preferably from approximately 40 wt. % to approximately 75 wt. %, of the at least one mineral filler, based on the total weight of the initiator component. The at least one mineral filler is selected to have a particle size complementary to that of the aluminum-containing cement.

In an advantageous embodiment, the initiator component can also comprise the following characteristics, alone or in combination.

The initiator component can additionally comprise a thickener. The thickener can be selected from the group consisting of bentonite, silicon dioxide, quartz, acrylate-based thickeners, such as alkali-soluble or alkali-swellable emulsions, quartz dust, clay and titanate chelating agents. Examples given are polyvinyl alcohol (PVA), hydrophobically modified alkali-soluble emulsions (HASE), hydrophobically modified ethylene oxide urethane polymers, which are known in the art as HEUR, and cellulose thickeners such as hydroxymethyl cellulose (HMC), hydroxyethyl cellulose (HEC), hydrophobically modified hydroxyethyl cellulose (HMHEC), sodium carboxymethyl cellulose (SCMC), sodium carboxymethyl-2-hydroxyethyl cellulose, 2-hydroxypropyl methyl cellulose, 2-hydroxyethyl methyl cellulose, 2-hydroxybutyl methyl cellulose, 2-hydroxyethyl ethyl cellulose, 2-hydroxypropyl cellulose, attapulgite clay, and mixtures thereof. Suitable thickeners are commercially available products such as Optigel WX (BYK-Chemie GmbH, Germany), Rheolate 1 (Elementis GmbH, Germany) and Acrysol ASE-60 (The Dow Chemical Company).

The initiator component can comprise at least approximately 0.01 wt. %, preferably at least approximately 0.05 wt. %, more preferably at least approximately 0.1 wt. %, most preferably at least approximately 0.3 wt. %, from approximately 0.01 wt. % to approximately 15 wt. %, preferably from approximately 0.05 wt. % to approximately 10 wt. %, more preferably from approximately 0.1 wt. % to approximately 5 wt. %, most preferably from approximately 0.3 wt. % to approximately 1 wt. %, of the thickener, based on the total weight of the initiator component.

The presence of a retarder and thickener does not alter the overall inorganic nature of the cementitious initiator component. A dispersant (plasticizer) can also optionally be present. Such dispersants are known to a person skilled in the art.

The initiator component, which comprises the initiator, is present in aqueous phase, preferably in the form of a slurry or paste.

It is preferred that the pH of the initiator component is above 10, more preferably above 11, and most preferably above 12, in particular in the range between 10 and 14, preferably between 11 and 13. It is particularly preferred that the proportions of water in the two components, namely component A and the initiator component, are selected such that the ratio of water to aluminum-containing cement (W/CAC) or water to calcium sulfoaluminate cement (W/CAS) in the product obtained by mixing components A and B is less than 1.5, preferably between 0.3 and 1.2, most preferably between 0.4 and 1.0.

The aluminate-containing component can be prepared as follows: the blocking agent containing phosphorus is mixed with water such that the pH of the mixture obtained is approximately 2. The plasticizer is optionally added and the mixture is homogenized. Aluminum-containing cement, optionally calcium sulphate and optionally a mineral filler are premixed and gradually added to the mixture while increasing the stirring speed, so that the pH of the mixture obtained is approximately 4. Finally, if necessary, the thickener and antimicrobial/biocide agent are added and mixed until the mixture is completely homogenized.

The initiator component can be prepared as follows: the accelerator is dissolved in an aqueous solution of an activator, optionally followed by the subsequent addition of a retarder and a dispersant and homogenization of the mixture. The filler or fillers can then be added gradually while increasing the stirring speed until the mixture homogenizes. Finally, the thickener can be added last until the mixture is completely homogenized.

The aluminate-containing component and the initiator component are in aqueous phase, preferably in the form of a slurry or paste, more preferably in the form of an aqueous suspension. In particular, the aluminate-containing component and the initiator component have a pasty to fluid appearance according to the respective compositions thereof. In a preferred embodiment, the aluminate-containing component and the initiator component are in the form of an aqueous suspension, thereby preventing setting at the time of mixing the two components.

The weight ratio between the aluminate-containing component and the initiator component is preferably between 10/1 and 1/1, and is preferably 3/1. The composition of the mixture preferably comprises 75 wt. % of the aluminate-containing component and 25 wt. % of the initiator component. In an alternative embodiment, the composition of the mixture comprises 88 wt. % of the aluminate-containing component and 12 wt. % of the initiator component.

The cementitious aluminate-containing inorganic system has an initial setting time of at least 5 minutes, preferably at least 10 minutes, more preferably at least 15 minutes, most preferably at least 20 minutes, particularly in the range from approximately 5 to 25 minutes, preferably in the range from approximately 10 to 20 minutes, after mixing the two components.

The screw that is used in the fastening arrangement according to the invention can, for example, be a thread-forming screw, such as a concrete screw or the like.

The term “thread-forming screw” is to be understood in such a way as to include both “thread-tapping screw”, which taps its mating thread without cutting, the surrounding material being solidified and also forming the nut thread, as well as “thread-cutting screw”, which cuts its mating thread and which is mainly screwed into a pre-drilled hole, in particular a blind hole.

A thread-forming screw can be understood in particular as a screw that has a shank and a thread having a thread outer diameter and a thread pitch. In particular, the ratio of the thread outer diameter to the thread pitch is in the range from 1.0 to 2.0, preferably from 1.2 to 1.6 and more preferably from 1.2 to 1.45. As a rule, the helix and shaft are made from one material and are in one piece. Alternatively, the helix and the shaft can also consist of different materials.

The fastening arrangement according to the invention is used with thread-forming screws in holes.

The holes can be recesses of natural or non-natural origin, i.e. cracks, crevices, boreholes and the like. These are typically blind holes or boreholes, in particular boreholes in various substrates, in particular mineral building materials or substrates, such as those based on concrete, aerated concrete, brickwork, limestone, sandstone, natural stone, glass and the like, and metal substrates such as those made of steel. The substrate is preferably concrete.

When the thread-forming screw is placed in the prefabricated hole in a substrate, the helix of the thread engages in a mating thread in the substrate, which forms the screw as it is screwed in, in the substrate. In particular, the helix does not completely engage in the mating thread in the substrate, so that a sufficiently large gap remains between the screw shank and the hole wall, which gap can be filled with the curable compound.

The fastening arrangement according to the invention is created by a hole being created in a substrate, the multi-component cementitious aluminate-containing inorganic system being introduced and the thread-forming screw being set.

For example, the fastening arrangement can be created by a blind hole being drilled into a concrete component, the multi-component cementitious aluminate-containing inorganic system being introduced in the form of a two-chamber system, in particular a two-chamber pouch system, and the thread-forming screw being set in a rotational manner. By turning the screw during setting, the two-chamber system is destroyed, i.e. opened, and the components of the cementitious aluminate-containing inorganic system are mixed. The mixture is pressed into the gap between the blind hole wall and the screw and is cured there to form the cured compound. The packaging of the two-chamber system is either ground up or at least crushed. Even if the packaging is not ground up but only crushed, this does not affect the performance of the fastening arrangement.

In particular, the fastening arrangement will be used for fastening purposes involving an increase in load capacity at temperatures above room temperature or at elevated temperatures, such as above 80° C., and/or an increase in bond strength when cured. Elevated temperature resistance results in better performance for fastening purposes, even at higher temperatures, such as temperatures present in the borehole region of facade fasteners exposed to strong sunlight or otherwise elevated temperatures.

The following examples illustrate the invention without thereby limiting it.

### EXAMPLES

### 1. Production of the Aluminate-Containing Component and the Initiator Component

The aluminate-containing component as well as the initiator component are initially produced by mixing the constituents specified in Tables 1 and 2, respectively. The proportions given are expressed in wt. %.

TABLE 1
Composition of the aluminate-containing component A1:

| Constituents of the aluminate- | |
|---|---|
| containing component | Component A1 |
| Water | 17.17 |
| Ternal White | 80.30 |
| 85% H₃PO₄ | 0.91 |
| Na-gluconate | 0.20 |
| Xanthan gum | 0.50 |
| Ethacryl G | 0.90 |
| Nuosept | 0.02 |

TABLE 2
Composition of the initiator components B1 and B2:

| Constituents of the Initiator | Initiator | Initiator |
|---|---|---|
| component | component B1 | component B2 |
| Water | 16.50 | 40.26 |
| NaOH (s) | 4.00 | 9.76 |
| Li₂SO₄ | 0.43 | 1.05 |
| Citric acid | 3.50 | 8.54 |
| Tartaric acid | 2.20 | 5.37 |
| Ecodis P50 | 0.65 | 1.59 |
| Quartz F32 | 32.27 | 0.00 |
| Corundum 70 | 17.53 | 0.00 |
| Omyacarb 130 | 9.22 | 0.00 |
| Omyabrite 1300 X-OM | 13.30 | 32.45 |
| Optigel WX | 0.40 | 0.98 |

### 2. Mixing Ratio

TABLE 3
Mixing ratio of the various components of the cementitious
aluminate-containing inorganic system

| | Ratio A1:B1 | Ratio A1:B2 |
|---|---|---|
| Examples | 3:1 = cementitious | 7.5:1 = cementitious |
| | aluminate-containing | aluminate-containing |
| | inorganic system | inorganic system |
| | Mortar 1 | Mortar 2 |

### 3. Determination of Mechanical Performance

After production, both components were mixed in a defined ratio of component A:B and filled into a hard plastics cartridge. The hard plastics cartridge was placed in a dispenser and the compound to be cured was injected into bores in a concrete slab. The bores had a depth of 150 mm and a diameter of 14 mm. The bores were cleaned by means of compressed air cleaning and brushing before the mortar was injected. A concrete screw having a conical spiral was then inserted into each bore. The pull-out strength was measured after 24 hours curing in order to measure the ability of the mortar to improve the anchorage of the steel element in the concrete. As a reference, the same concrete screw was installed in bores of similar dimensions with similar cleaning procedures, but without prior injection of any mortar. The results of the pull-out tests are listed in Table 4.

TABLE 4
Pull-out values in kN of the concrete screw with and without
a cementitious aluminate-containing inorganic system

| | | Screw and | Screw and |
|---|---|---|---|
| Pull-out test | Screw | mortar 1 | mortar 2 |
| Pull-out value in kN | 55.15 | 76.92 | 92.38 |

By using a cementitious aluminate-containing inorganic system with a concrete screw (in the example screw anchor (concrete screw) HUS3, Hilti, Germany), the bond is strengthened, leading to an increase in the load values, which, due to the mainly inorganic constituents of the mortar, can also be maintained at high in-service temperatures and in the event of a fire.

These results also show that the cementitious aluminate-containing inorganic system, which can be easily stored and activated by adding an additive such as sodium hydroxide if necessary, can significantly improve the load values of a concrete screw in concrete. In addition, the use of an initiator component having a low filling level and only fine filler leads to easier setting of the concrete screw and increases the load values with very little scatter.

1. A fastening arrangement, comprising:
a screw which has a shank and at least one thread helix, the thread helix being arranged on the shank, and
an aluminate-containing inorganic cured compound,
the screw being arranged in a hole in a substrate and a gap being provided between the shank and the hole wall, which gap is filled with the cured compound,
wherein the aluminate-containing inorganic cured compound is obtained by curing a multi-component cementitious system, which contains, in one component, at least one aluminate-containing cement constituent and at least one blocking agent selected from the group consisting of phosphoric acid, metaphosphoric acid, phosphorous acid, phosphinic acids and boric acid, in aqueous phase, and, in a further component, an initiator for the aluminate-containing cement constituent.

2. The fastening arrangement according to claim 1, wherein the initiator comprises a mixture of alkali and/or alkaline earth metal salts.

3. The fastening arrangement according to claim 1, wherein the initiator consists of an activator component and an accelerator component.

4. The fastening arrangement according to claim 3, wherein the activator component comprises alkali hydroxide and the accelerator component comprises a lithium salt.

5. The fastening arrangement according to claim 4, wherein the activator component is sodium hydroxide and the accelerator component is lithium sulfate.

6. The fastening arrangement according to claim 1, wherein the further component contains at least one retarder selected from the group consisting of citric acid, tartaric acid, lactic acid, salicylic acid, gluconic acid and mixtures thereof.

7. The fastening arrangement according to claim 1, wherein the further component contains at least one mineral filler selected from the group consisting of limestone fillers, sand, corundum, dolomite, alkali-resistant glass, crushed stones, gravel, pebbles and mixtures thereof.

8. The fastening arrangement according to claim 1, wherein the aluminate-containing cement constituent is based on a calcium aluminate cement (CA) in aqueous phase or on a calcium sulfoaluminate cement (CAS) in aqueous phase.

9. The fastening arrangement according to claim 1, wherein the pH of the further component is over 10.

10. The fastening arrangement according to claim 1, wherein the aluminate-containing component also comprises a plasticizer.

11. The fastening arrangement according to claim 1, wherein the aluminate-containing component and the further component are in the form of an aqueous suspension.

12. The fastening arrangement according to claim 1, wherein the substrate is a mineral building material.

13. The fastening arrangement according to claim 1, wherein the thread helix engages in a mating thread in the substrate.

14. The fastening arrangement according to claim 1, wherein the thread helix has a thread outer diameter and a thread pitch, the ratio of the thread outer diameter to the thread pitch being in the range from 1.0 to 2.0.

15. The fastening arrangement according to claim 1, wherein the screw is a concrete screw.

16. The fastening arrangement according to claim 1, wherein the further component contains at least one retarder selected from the group consisting of citric acid, tartaric acid and mixtures thereof.

17. The fastening arrangement according to claim 1, wherein the substrate is concrete.

18. The fastening arrangement according to claim 1, wherein the thread helix has a thread outer diameter and a thread pitch, the ratio of the thread outer diameter to the thread pitch being in the range from 1.2 to 1.6.
